(19) United States
(12) Patent Application Publication
(10) Pub. No.: US 2004/0131874 A1
(43) Pub. Date: Jul. 8, 2004

(54) Reducing odor in fiberglass insulation bonded with urea-extended phenol-formaldehyde resins

(75) Inventors: Kim Tutin, Stone Mountain, GA (US); Carl R. White, Conyers, GA (US); David J. Bir, Conyers, GA (US); Kurt D. Gabrielson, Lilburn, GA (US); Ted McVay, Snellville, GA (US); Kathy Dalburg, Dallas, GA (US)

Correspondence Address: BANNER & WITCOFF, 1001 G STREET N W, SUITE 1100, WASHINGTON, DC, 20001, US

(73) Assignee: Georgia-Pacific Resins, Inc., Atlanta, GA

(21) Appl. No.: 10/338,029

(22) Filed: Jan. 8, 2003

(51) Int. Cl. C08F 2/00; B32B 5/02; C08F 4/00; B32B 17/02; B32B 27/42; D04H 1/00; D04H 3/00; D04H 5/00; D04H 13/00

(52) U.S. Cl. 428/524; 442/172; 442/176; 526/89

(57) ABSTRACT

A binder composition based on phenol-formaldehyde resin for making fiberglass insulation and related fiberglass products (glass fiber products) and containing a copper or vanadium odor-eliminating agent, such as cupric chloride, that when cured exhibits a lower amount of odor caused by the presence of trimethylamine.

### FIELD OF THE INVENTION

The present invention relates to a binder composition based on phenol-formaldehyde resins, and especially urea-extended phenol-formaldehyde resins, for making fiberglass insulation and related fiberglass products (glass fiber products) that exhibit a lower amount of odor. The invention is particularly directed to glass fiber products bonded with a cured urea-extended phenol-formaldehyde resin binder composition, which includes a copper or vanadium odor-eliminating agent, preferably selected from the group consisting of copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅), the cured binder having a lowered trimethylamine (TMA) content.

### BACKGROUND OF THE INVENTION

Phenol-formaldehyde (PF) resins, as well as PF resins extended with urea (PFU resins), have been the mainstays of fiberglass insulation binder technology over the past several years. Such resins are inexpensive and provide the cured fiberglass insulation product with excellent physical properties.

One of the drawbacks of this technology, however, is the potential for formaldehyde emissions during the manufacturing of the fiberglass insulation.

Fiberglass insulation is typically made by spaying a dilute aqueous solution of the PF or PFU resin-based binder onto a moving mat or blanket of non-woven glass fibers, often hot from being recently formed, and then heating the mat or blanket to an elevated temperature in an oven to cure the resin. As a result, free phenol and free formaldehyde in the resin can easily volatilize during use. Manufacturing facilities using PF and PFU resins as the main binder component for insulation products have had to invest in pollution abatement equipment to minimize the possible exposure of workers to such emissions and to meet Maximum Achieveable Control Technology (MACT) requirement Standards.

One widely used approach for reducing the potential for formaldehyde emission has been to add urea, melamine, or ammonia, as a formaldehyde scavenger, to the binder composition before it is applied to the glass fibers. Urea is the most commonly used additive. These materials convert free formaldehyde in the resole resin solution into hexamethylenetetramine, a mixture of mono and dimethylol ureas, and/or mono, di, or trimethylolated melamine.

One of the consequences of this approach to converting the free formaldehyde into less obnoxious chemicals is that resulting adducts, particularly hexa-methylenetetramine, and mono and dimethylol ureas can all contribute to the production of trimethylamine in the cured phenolic binder, which gives the cured phenolic binder and accordingly the finished product an undesirable “fishy” odor.

The present invention involves the addition, at some time prior to the use of the resin, of certain copper and vanadium odor-eliminating materials to a phenol-formaldehyde resin-based binder composition that has been treated with urea, melamine, ammonia, or a combination thereof to reduce free formaldehyde where the binder is to be used to bind glass fiber products, especially fiberglass insulation. The addition of such materials to the binder helps to reduce the undesired formation of trimethylamine and thus eliminate (control) odor in the cured binder.

Lane and Yoke, “Oxidation of Trimethylamine by Copper (II) Chloride” Vol. 15, No. 2, Inorganic Chemistry, pp. 484-85 (1976), describes experimental results for coordination and oxidation of trimethylamine (TMA) by copper (II) chloride, where dimethylmethyleneammonium formed by the oxidation process and formaldehyde and dimethylamine were formed as hydrolysis products thereof. Lane and Yoke noted that oxidation of TMA by copper (II) chloride is similar to its oxidation by vanadium (IV) chloride.

U.S. Pat. No. 4,385,632 to Odelhog relates to a germicidal absorbent body for collecting human waste comprising a body of cellulose fibers or wadding impregnated with an odor-inhibiting and germicidal solution of a water-soluble copper salt. The presence of the copper salt prevents bacteria growth and thereby controls odor by preventing the bacterial-induced formation of ammonia from urea. The copper salt solution is selected from the group consisting of copper formate, copper oxalate, copper tartrate, copper citrate, copper lactate, copper sulfate, copper chloride, copper acetate and copper borate.

U.S. Pat. No. 5,306,487 to Karapasha et al. relates to compositions for use in the manufacture of diapers, catamenials and pantiliners, which include zeolites and activated carbon odor-controlling agents, gelling material and binder material. The composition is directed to controlling ammonia odors. Optional adjunct odor-controlling materials are discussed at column 17, line 60 to Column 18, line 5 and include copper salts and copper ions.

### DETAILED DESCRIPTION OF THE INVENTION

The present invention is directed to a method for making glass fiber products using a particular binder composition so as to reduce the amount of trimethylamine (TMA) in the resulting cured binder composition, wherein the binder is based on phenol-formaldehyde resole resins treated with urea, melamine, ammonia or some combination thereof for reducing formaldehyde emission.

The present invention is specifically directed to a phenol-formaldehyde resin-based binder composition suitable for making glass fiber products, particularly a phenol-formaldehyde resole resin treated with urea, melamine, ammonia or some combination thereof for reducing formaldehyde emission from the binder during its handling and cure, characterized by the addition of a copper or vanadium odor-eliminating agent to the binder composition. The odor-eliminating agent is preferably selected from the group consisting of copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅), and the odor-eliminating agent is blended into the binder composition some time before the binder is cured on the glass fibers.

Thus, in one aspect, the present invention is directed to an aqueous binder composition suitable for making glass fiber products, and particularly useful for making fiberglass insulation, wherein the binder comprises (1) a phenol-formaldehyde resole resin that has been treated with urea, melamine, ammonia, or some combination thereof for reducing formaldehyde emission from the binder, such as during its cure and (2) a copper or vanadium odor-eliminating agent, wherein the odor-eliminating agent is preferably selected from the group consisting of copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅).

In another aspect, the present invention provides a method for binding together a loosely associated mat or blanket of glass fibers comprising (A) applying onto said glass fibers an aqueous binder composition comprising (1) a phenol-formaldehyde resole resin that has been treated with urea, melamine, ammonia, or some combination thereof for reducing formaldehyde emission from the binder, such as during its cure and (2) a copper or vanadium odor-eliminating agent, wherein the odor-eliminating agent is preferably selected from the group consisting of copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅), and (B) heating said binder composition at an elevated temperature, which temperature is sufficient to effect cure of the binder. Preferably, curing is effected at a temperature from 75° C. to 300° C. and usually at a temperature less than 275° C.

In yet another aspect, the present invention provides a glass fiber product, especially a glass fiber insulation product (fiberglass insulation), comprising glass fibers interconnected by a crosslinked (cured) binder composition obtained by curing a binder composition comprising (1) a phenol-formaldehyde resole resin that has been treated with urea, melamine, ammonia, or some combination thereof for reducing formaldehyde emission from the binder composition, such as during its cure and (2) a copper or vanadium odor-eliminating agent, wherein the odor-eliminating agent is preferably selected from the group consisting of copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅); the binder having been applied to a mat or blanket of non-woven glass fibers, preferably a mat or blanket of principally glass fibers and especially a mat or blanket of only glass fibers and then heat cured.

In use, the binder composition made with a phenol-formaldehyde resole resin that has been treated with urea, melamine, ammonia, or some combination thereof for reducing formaldehyde emission and to which the odor-eliminating agent has been added some time prior to the use (cure) of the binder, wherein the odor-eliminating agent is preferably selected from the group consisting of copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅), is applied as a dilute aqueous solution to a mat or blanket of glass fibers. The binder containing the resole resin and the odor-eliminating agent is cured by heat.

As used herein, “curing,” “cured” and similar terms are intended to embrace the structural and/or morphological change which occurs in the aqueous binder of the phenol-formaldehyde resole resin as it is dried and then heated to cause the properties of the binder, applied to a mat or blanket of glass fibers, to be altered such as, for example, by covalent chemical reaction, ionic interaction or clustering, improved adhesion to the substrate, phase transformation or inversion, and hydrogen bonding.

As used herein, “aqueous” includes water and mixtures composed substantially of water and water-miscible solvents.

As used herein the phrases “glass fiber,” “fiberglass” and the like are intended to embrace heat-resistant fibers suitable for withstanding elevated temperatures such as mineral fibers, aramid fibers, ceramic fibers, metal fibers, carbon fibers, polyimide fibers, certain polyester fibers, rayon fibers, and especially glass fibers. Such fibers are substantially unaffected by exposure to temperatures above about 120° C. and up to 300° C. and higher, as appreciated by those skilled with their use. If intended to embrace predominately and/or only fibers made from glass, i.e., a material made predominately from silica, then a phrase such as “principally glass fiber” or “only glass fiber,” will be used.

As used throughout the specification and claims, the terms mat and blanket are used somewhat interchangeably to embrace a variety of glass fiber substrates of a range of thickness and density, made by entangling short staple fibers, long continuous fibers and mixtures thereof.

The present invention is not limited to any particular phenol-formaldehyde resole resin for making the binder composition of the present invention. As well known to those skilled in the art, curable phenol-formaldehyde resole resins are conventionally used for making binder compositions for glass fiber products.

Resole resins are aqueous, base catalyzed, phenol-formaldehyde adducts made with a molar excess of formaldehyde, using procedures well known to skilled workers. For example, as is conventional, a resole can be prepared using a basic catalyst typically having a pK of greater than about 9. Known bases for making resole resins include alkali metal hydroxides such as lithium hydroxide, sodium hydroxide and potassium hydroxide; alkali metal carbonates such as sodium carbonate and potassium carbonate; alkaline earth hydroxides such as magnesium hydroxide, calcium hydroxide and barium hydroxide; aqueous ammonia and amines of molecular weight less than 300. Such conventional aqueous, resole resins are appropriate for use in this invention.

For example, a phenol-formaldehyde resole resin may be prepared according to the following method in which phenol is methylolated by a suitable aldehyde. The preferred aldehyde is formaldehyde. Formaldehyde is available in many forms. Paraform (a solid, polymerized formaldehyde) and formalin solutions (aqueous solutions of formaldehyde, sometimes with methanol, in 37%, 44%, or 50% formaldehyde concentrations) are commonly used forms. Formaldehyde also is available as a gas. Any of these forms is suitable. Further, the formaldehyde may be partially or totally replaced with any suitable aldehyde as known in the art, though cost considerations almost exclusively favor formaldehyde. Typically, aqueous formalin solutions low in methanol are preferred as the formaldehyde source.

An initial charge of phenol is mixed with an excess of aldehyde. Preferably, the aldehyde:phenol molar ratio is about 2:1 to about 6:1, more preferably about 3.5 to about 4.25:1. Phenol/formaldehyde binders made using an aldehyde:phenol mole ratio in the range of about 3.5:1 to about 4.25:1 are especially useful in binding glass fibers to form thermal insulation mats. The methylolation reaction between phenol and the aldehyde takes place under aqueous alkaline conditions. Preferably, the pH is about 7.5 to about 10.0, more preferably about 8.5 to about 9.5. The methylolation reaction preferably takes place in the presence of an effective amount of an alkaline methylolation catalyst. Usually, the methylolation catalyst constitutes about 3 to about 20% by weight, and most often about 5 to about 15% by weight, based on the initial charge of phenol.

Methylolation of phenol may take place at a temperature of less than 70° C., preferably at about 50° C. to about 65° C. The exothermic reaction mixture is cooked for a sufficient period of time to reduce free phenol to the desired level, such as to not more than about 0.35 wt. % for a resin having about 40-50% solids content by weight. Usually, the resole resin is cooked until free phenol is reduced to not more than about 0.25%. Preparation of the phenolic resole resin is generally considered complete when a desired free phenol level is reached. The free phenol level is determined using analytic techniques, such as gas chromatography, generally known to those skilled in the art. Preferably, once the desired free phenol level is reached, the resole resin is cooled to less than about 30° C.

As representative and not as limiting examples, the phenol-formaldehyde resole resins prepared in Walisser et al., U.S. Pat. No. 5,952,440, the phenol-formaldehyde resole resins made by the two step process of Higginbottom U.S. Pat. No. 4,028,367, or by the carefully controlled two-stage process of co-pending application entitled INVERTED NOVOLAC RESIN-TYPE INSULATION BINDER U.S. Ser. No. 10/282,238, filed on Oct. 29, 2002, or the phenol-formaldehyde resole resins prepared in Bristol et al, U.S. Patent Application Publication 2001/0036996 also can all be used. The entire disclosures of these patents and patent applications are hereby incorporated herein by reference.

In order to reduce the emission of formaldehyde from such phenol-formaldehyde resole resins and from binder compositions made from such resins, during the handling and cure of the resins and binders, formaldehyde scavengers are often added to the resin or binder composition. In particular, sufficient urea, melamine, ammonia, or some combination thereof generally is added as a formaldehyde scavenger to reduce the free formaldehyde content of the phenol-formaldehyde resole resin in the binder composition to a low level. Urea is the most commonly used material.

As recognized by those skilled in the art, it is preferred to use a formaldehyde scavenger in an amount to provide about 0.5 to 4.0 mole equivalents of free formaldehyde per mole of scavenger, and more particularly 0.8 to 1.0 mole equivalents of free formaldehyde per mole of urea scavenger. As is well understood by those skilled in the art, free formaldehyde is that formaldehyde remaining un-reacted (un-combined) in the phenol-formaldehyde resole resin.

Following the addition of the formaldehyde scavenger to the resin, or to the formulated binder composition, the resin, or binder normally is maintained at a temperature of about 20° to about 60° C. for a period of time sufficient to cause a reaction between scavenger and free formaldehyde and to reduce the level of free formaldehyde in the resin or binder. The time and temperature is preferably adjusted to minimize any oligomerization of the resole resin. These scavenger materials react with free formaldehyde in the resole resin or binder forming hexamethylenetetramine and methyloated amines/amides, such as monomethylol urea.

Unfortunately, the hexamethylenetetramine and mono and dimethylol ureas in the resole resin (or binder solution) can lead to the formation of trimethylamine (TMA) in the ultimately cured phenol-formaldehyde resole resin-based binder, which gives the cured phenolic binder and accordingly the finished glass fiber product an undesirable “fishy” odor.

For example, fiberglass insulation made for the largest segment of the insulation market typically includes as much as 30% to 40% by weight urea. Thus, these products tend to exhibit very high residual levels of TMA.

In accordance with the present invention, the potential problem of residual TMA in the cured binder composition is addressed by including in the phenol-formaldehyde resole resin a copper or vanadium odor-eliminating agent of the present invention. The odor-eliminating agent can be added to the resole resin either prior to making the binder composition, when the resin is formulated into a dilute aqueous binder composition and before applying it to the glass fibers, or as the aqueous binder composition is being applied to the glass fibers. For example, the odor-eliminating agent may be added to the binder by applying, such as by spraying, a solution, preferably an aqueous solution, of the odor-eliminating agent onto the glass fibers separately from the application of an aqueous binder composition to the glass fibers. In this way, the odor-eliminating agent becomes intermixed with the phenol-formaldehyde resole resin before it is cured.

The binder composition is usually applied to glass fibers as the glass fibers are being produced and formed into a mat or blanket. Water is volatilized from the binder as it contacts the hot fibers, and the high-solids binder-coated fibrous glass mat is heated to cure the binder in the presence of the odor-eliminating agent and thereby produce a finished glass fiber product, e.g., a fiberglass insulation product having a lower TMA odor.

A phenol-formaldehyde resole resin solution can readily be made into an aqueous binder composition and is usually done at the site where the binder will be used. To prepare the binder, a number of ingredients generally are added to an aqueous resole resin. If not previously done at the site of resin synthesis, one of the usual ingredients to be added is the formaldehyde scavenger of urea, melamine, ammonia, or a combination thereof. Urea is, by far, the most commonly used binder additive when preparing a binder for making fiberglass insulation. Following addition of the scavenger to the binder (or to the resin) a sufficient period of time, when using urea usually a period of about 3 to 16 hours, while for ammonia the reaction is almost instantaneous, is provided before the binder is used to allow the scavenger time to pre-react with the free formaldehyde in the phenol-formaldehyde resole resin or binder solution.

Following this pre-reaction with scavenger, the phenol-formaldehyde resin solution then is diluted with additional water and other binder ingredients are often added.

The combination of formaldehyde scavenging and water dilution usually reduces the free formaldehyde content in the binder composition to less than about 0.5%.

One of the other optional and in some cases a preferred ingredient for the binder composition, which can be added either at the time the resole resin is prepared, or at the time the binder is prepared, is a urea-formaldehyde (UF) resin, especially a cyclic urea prepolymer, such as described in Dupre et al., U.S. Pat. No. 6,114,491, the entire disclosure of which is hereby incorporated by reference (see particularly Example 1a). UF resins are well-known to skilled workers. For example, suitable UF resins may be formed by aqueous alkaline reactions between urea and formaldehyde. Other examples of preferred cyclic urea prepolymer additives for the resin and binder are described in U.S. Pat. Nos. 2,641,584 and 4,778,510, the disclosures of which also are incorporated by reference herein in their entirety. Such prepolymers are formed by reactions among urea, formaldehyde and ammonia and typically contain triazone, substituted triazones and mono-, di-, and tri-substituted ureas. The UF resins and cyclic urea prepolymers can be considered as resin/binder extenders. The use of the cyclic urea prepolymer additive in such resins and binders, in particular, has resulted in lowered phenol emissions and lower overall binder cost.

In accordance with the present invention, either at the time the resole resin is prepared, or preferably just prior to the curing of the binder composition made from the resole resin, a copper or vanadium odor-eliminating agent preferably selected from the group consisting of copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅), is added to the resole resin or to the binder composition in order to reduce the level of TMA subsequently present in the cured binder composition.

Sufficient odor-eliminating agent is added to the resin or to the binder so as to reduce the content of TMA in the resulting cured binder composition. Cupric chloride is a preferred odor-eliminating agent. The odor-eliminating agent is added to the resole resin or to the binder in an amount sufficient to reduce the level of TMA in the cured binder to an acceptable level. Typically, the odor-eliminating agent is added in an amount of from about 1 wt. % to about 20 wt. % based on the weight of curable binder solids. Preferably, the odor-eliminating agent is added in an amount of from about 5 wt. % to about 15 wt. % based on the weight of curable binder solids. As used herein, the phrase curable binder solids refers to the phenol-formaldehyde resole resin and any extender/scavenger reaction products.

The level of trimethylamine (TMA) reduction observed in the cured binder is directly related to the amount of odor-eliminating agent, e.g., copper (II) chloride, added to the resole resin or binder, thereby allowing optimization of the trimethylamine level for a particular product. Though not wishing to be bound by any particular theory, the odor-eliminating agent added to the phenol-formaldehyde resin-based binder composition interferes with the formation of and/or contributes to the destruction of TMA in the ultimately cured binder composition. In this way, the residual TMA content of the cured binder composition is reduced or eliminated causing a reduction in the objectionable “fishy” smell often encountered in products containing such cured binder composition, such as fiberglass insulation products.

As will be understood by those skilled in the art, the phenol-formaldehyde resole resin also can be blended with other common (optional) glass fiber binder ingredients and diluted to a low concentration for making the binder composition, which can then be sprayed onto the fibers as they fall onto the collecting conveyor. The binder composition is generally applied to the fibers in an amount such that the cured binder constitutes about 3 wt. %, more usually about 5 wt. %, up to about 15 wt. % of the finished glass fiber products, e.g., fiberglass insulation product, although it can be as little as 1 wt. % or less and as high as 20 wt. % or more, depending upon the type of glass fiber product. Optimally, the amount of binder for most thermal insulation products will be the amount necessary to lock each fiber into a mass by bonding the fibers where they cross or overlap. For this reason, it is desired to have binder compositions with good flow characteristics, so that the binder solution can be applied to the fiber at a low volume that will flow to the fiber intersections.

The binder formulation needs to be stable for a period of time long enough to permit mixing and application to the glass fibers at temperatures ordinarily encountered in glass fiber product manufacturing facilities, such as fiberglass insulation product manufacturing plants. Such times may typically be greater than 4 hours. Alternatively, if the glass fiber manufacturer has an in-line binder mixing system, the phenol-formaldehyde resin solution may be diluted and immediately applied to the fibers. In this circumstance, binder stability may be less of a concern.

To prepare a binder composition, it may also be advantageous to add a silane coupling agent (e.g., organo silicon oil) to the phenol-formaldehyde resin solution in an amount of at least about 0.05 wt. % based on the weight of binder solids. Suitable silane coupling agents (organo silicon oils and fluids) have been marketed by the Dow-Corning Corporation, Petrarch Systems, and by the General Electric Company. Their formulation and manufacture are well known such that detailed description thereof need not be given. When employed in the binder composition of this invention, the silane coupling agents typically are present in an amount within the range of about 0.1 to about 2.0 percent by weight based upon the binder solids and preferably in an amount within the range of 0.1 to 0.5 percent by weight. Representative silane coupling agents are the organo silicon oils marketed by Dow-Corning Corporation; A0700, A0750 and A0800 marketed by Petrarch Systems and A1100 (an amino propyl, trimethoxy silane) or A1160 marketed by Dow Chemical Corporation. This invention is not directed to and thus is not limited to the use of any particular silane additives.

The binder may be prepared by combining the phenol-formaldehyde resole resin, the silane coupling agent and any other optional ingredients in a relatively easy mixing procedure carried out at ambient temperatures. The binder then can be used immediately. The binder is diluted with water to a concentration suitable for the desired method of application, such as by spraying onto the glass fibers. The odor-eliminating agent either is present in the binder prior to application of the binder onto the glass fibers, or is added to the binder coincident with application of the binder to the glass fibers.

Still other conventional binder additives compatible with aqueous phenol-formaldehyde resole resins, the optional UF resin or the cyclic urea prepolymer (when used) and the optional silane coupling agent (when used) also may be added to the binder destined for application to the glass fibers. Such additives include such conventional treatment components as, for example, emulsifiers, pigments, fillers, lignin, anti-migration aids, curing agents, coalescents, wetting agents, dedusting agents, biocides, plasticizers, anti-foaming agents, colorants, such as carbon black, waxes, and anti-oxidants

Often a latent catalyst also is added to the binder. Though its use sometimes is optional, a latent catalyst tends to be used in most applications. The latent catalyst most often used in the industry is ammonium sulfate, but ammonium salts of other strong acids could alternatively be employed. Alternatively, an acid catalyst such as sulfuric acid, oxalic acid, methanesulfonic acid, toluene-sulfonic acid and phenolsulfonic acid, may be used directly.

The particular method for forming glass fibers for use in the present invention is relatively unimportant. Processes for making glass fiber products, and especially fiberglass insulation products using a phenol-formaldehyde resole-based binder composition and odor-eliminating agent of the present invention are typically carried out according to one of a number of methods wherein a molten mineral material flowing from a melting furnace is divided into streams and attenuated into fibers. The attenuation can be done by centrifuging and/or by fluid jets to form discontinuous fibers of relatively small dimensions, which typically are collected by randomly depositing on a moving foraminous (porous) conveyor belt. The fibers are collected in a felted haphazard manner to form a mat. The volume of fiber in the mat (including diameters and lengths) will be determined by the speed of fiber formation and the speed of the belt.

Continuous glass fibers also may be employed in the form of mats or blankets fabricated by swirling the endless filaments or strands of continuous fibers, or they may be chopped or cut to shorter lengths for mat or batt formation. Use can also be made of ultra-fine fibers formed by the attenuation of glass rods. Also, such fibers may be treated with a size, anchoring agent or other modifying agent before use.

Glass fiber insulation products may also contain fibers that are not in themselves heat-resistant such as, for example, certain polyester fibers, rayon fibers, nylon fibers, and superabsorbent fibers, in so far as they do not materially adversely affect the performance of the glass fiber product.

In order to produce most glass fiber products and especially fiberglass thermal insulation products, the fibers must be bonded together in an integral structure. To achieve this binding, a binder based on a urea-, melamine-, and/or ammonia-treated, curable phenol-formaldehyde resole resin with the added odor-eliminating agent of the present invention is applied to the glass fiber mat or blanket. When making fiberglass insulation, the layer of fiber with binder is then mildly compressed and shaped into the form and dimensions of the desired thermal insulation product. The insulation product then is passed through a curing oven where the binder is cured fixing the size and shape of the finished insulation product.

With the inclusion of the odor-eliminating agent in the cured binder composition, the level of TMA in the cured binder, and the accompanying “fishy” odor, can be significantly reduced.

The binder composition (and the odor-eliminating agent) may be applied to the fiberglass by conventional techniques such as, for example, air or airless spraying, padding, saturating, roll coating, curtain coating, beater deposition, and coagulation. For example, the binder composition can be applied to the glass fibers by flooding the collected mat of glass fibers and draining off the excess, by applying the binder composition onto the glass fibers during mat or blanket formation, by spraying the glass fiber mat or the like. As noted above, the layer of fiber with binder can then be mildly compressed and shaped into the form and dimensions of the desired insulation product such as pipe, batt or board and passed through a curing oven where the binder is cured, thus fixing the size and shape of the finished insulating product by bonding the mass of fibers one to another and forming an integral composite structure.

The aqueous binder composition, after it is applied to the glass fiber and in the presence of the odor-eliminating agent, is heated to effect drying and curing. The duration and temperature of heating will affect the rate of drying, processability and handleability, degree of curing and property development of the treated substrate. The curing temperatures are generally within the range from 100 to 300° C., preferably within the range from 150 to 275° C. and the curing time will usually be somewhere between 3 seconds to about 15 minutes.

On heating, water present in the binder composition evaporates, and the composition undergoes curing. These processes can take place in succession or simultaneously. Curing in the present context is to be understood as meaning the chemical alteration of the composition, for example crosslinking through formation of covalent bonds between the various constituents of the composition, formation of ionic interactions and clusters, formation of hydrogen bonds. Furthermore, the curing can be accompanied by physical changes in the binder, for example phase transitions or phase inversion.

As noted, the drying and curing functions may be accomplished in two or more distinct steps, if desired. For example, the composition may be first heated at a temperature and for a time sufficient to substantially dry but not to substantially cure the binder composition and then heated for a second time at a higher temperature and/or for a longer period of time to effect curing. Such a procedure, referred to as “B-staging”, may be used to provide binder-treated product, for example, in roll form, which may at a later stage be cured, with or without forming or molding into a particular configuration, concurrent with the curing process. This makes it possible, for example, to use the compositions of this invention for producing binder-impregnated semi-fabricates, which can be molded and cured elsewhere. The uncured B-staged material often may be stored for up to two months before final curing.

The glass fiber component will represent the principal material of the glass fiber products, such as a fiberglass insulation product. Usually 99-60 percent by weight of the product will be composed of the glass fibers, while the amount of phenol-formaldehyde resole resin binder solids will broadly be in reverse proportion ranging from 1-40 percent, depending upon the density and character of the product. Glass insulations having a density less than one pound per cubic foot may be formed with binders present in the lower range of concentrations while molded or compressed products having a density as high as 30-40 pounds per cubic foot can be fabricated of systems embodying the binder composition in the higher proportion of the described range.

Glass fiber products can be formed as a relatively thin product, such as a mat having a thickness of about 10 to 50 mils; or they can be formed as a relatively thick product, such as a blanket of 12 to 14 inches or more. Glass fiber products of any thickness are embraced by the present invention. The time and temperature for cure for any particular glass fiber product will depend in part on the amount of binder in the final structure and the thickness and density of the structure that is formed and can be determined by one skilled in the art using only routine testing. For a structure having a thickness ranging from 10 mils to 1.5 inch, a cure time ranging from several seconds to 1-5 minutes usually will be sufficient at a cure temperature within the range of 175°-300° C.

Glass fiber products may be used for applications such as, for example, insulation batts or rolls, as reinforcing mat for roofing or flooring applications, as roving, as microglass-based substrate for printed circuit boards or battery separators, as filter stock, as tape stock, and as reinforcement scrim in cementitious and non-cementitious coatings for masonry.

Generally, insulation blankets are cut into the desired size and shape immediately following binder cure, compressed, packaged and shipped to distribution locations.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention, which is limited only by the appended claims.

### EXAMPLE 1

### Resole Resin Preparation

Formaldehyde, 63.9 parts by weight of a 50% aqueous solution, is added to a reactor equipped with an agitator, heater and reflux condenser. Phenol, about 25 parts by weight, is added with mixing. Once the phenol and formaldehyde have been thoroughly mixed, the temperature is adjusted to about 53° C. and vacuum reflux is established. The alkaline catalyst, sodium hydroxide, in an amount of 2.5 parts by weight of a 50 wt. % aqueous solution, then is added over a period of about 1 hour and 15 minutes or longer so as to maintain the reaction temperature at about 53° C. Once the alkaline catalyst has been added, the reaction is permitted to exotherm in a controlled fashion to 63° C. over a period of 30 minutes. Then, the resin is held at a temperature of 63° C. until the free formaldehyde level has been reduced to about 14% (measuring the free formaldehyde content every 15 minutes) or for a hold time of 130 minutes, which ever occurs first. At this point, the resin is cooled rapidly to about 35° C. and then neutralized with 35 wt % sulfuric acid to a pH of about 7.4 Following neutralization of the resin, urea, about 4.6 parts by weight, is rapidly added and once dissolved the resin is cooled to about 16° C. and the pH is again adjusted, as needed to about 7.4

### EXAMPLE 2

### Binder Preparation

Using as ingredients, the urea-treated resole resin of Example 1 (PF resin), a 40% by weight aqueous urea solution, a cyclic urea prepolymer (triazone resin) available from Georgia-Pacific Resins, Inc. (GPRI) under the commercial designation RUUI 458T95, ammonium hydroxide (supplied as an aqueous 28 wt. % solution), ammonium sulfate (supplied as an aqueous 20 wt. % solution) and water, several binder compositions were prepared. The binders were made by first forming a premix using such ingredients and allowing the premix to “pre-react” either overnight, or at least 8 hours, at room temperature. Then, additional ingredients were added to complete each binder composition. Each of the binders was formulated to have a solids concentration of 15 wt. %. The parts by weight of the various ingredients are illustrated in Table 1 as follows:

TABLE 1

| PREMIX | | | | | BINDER | | | | |
|---|---|---|---|---|---|---|---|---|---|
| (parts by weight) | | | | | (parts by weight) | | | | |
| Binder | PF | 40% | Triazone | 28% | | | Triazone | 20% | |
| No. | Resin | Urea | Resin | NH₄OH | Premix | Water | Resin | NH₄SO₄ | CuCl₂ |
| 1 | 182.1 | 103.1 | | 1.88 | 287.1 | 529.1 | | 17.2 | — |
| 2 | 123.6 | 107.8 | 53.2 | 1.88 | 286.5 | 529.6 | | 17.2 | — |
| 3 | 123.6 | 107.8 | 53.2 | 1.88 | 286.5 | 546.8 | | — | — |
| 4 | 123.6 | 107.8 | 53.2 | 1.88 | 286.5 | 517.1 | | 17.2 | 12.5 |
| 5 | 123.6 | 89.1 | 69.2 | 1.88 | 283.7 | 532.4 | | 17.2 | — |
| 6 | 108.7 | — | — | — | 108.7 | 816.2 | 159.6 | 17.2 | — |

In addition, 28% ammonium hydroxide was added as needed to adjust the pH of each of the binder formulations to 8.0. In particular, 0.83 parts, 0.44 parts, 0.41 parts, 15.8 parts, 0.42 parts and 5.2 parts ammonium hydroxide was added to binders 1-6, respectively.

### EXAMPLE 3

### Preparation of Molded Fiberglass

Binder preparations 1 through 6 were separately applied to 1 inch B-010 fiberglass by drawing a fine mist of the binder through the fiberglass until approximately 4-5 grams of binder was deposited on the fiberglass. The fiberglass mat then was cured in a steel mold set to a thickness of ½ inch (1.27 cm) at temperature of 525° F. (274° C.) for 1 minute. The cured mats were cut into one inch (2.54 cm) cubes and tested for TMA content according to the following procedure.

Twelve grams of the cured one inch (2.54 cm) cubes were weighed and placed in cheesecloth. Ten grams of distilled water were placed into a 1 quart (0.95 L) mason jar containing an inverted 50 ml glass beaker. The fiberglass cubes were placed on top of the 50 ml glass beaker in the Mason jar and the mason jar was sealed. The sealed jar was then incubated in a forced air oven at 65° F. (18° C.) for 16 hours. The jar was removed and allowed to cool to room temperature and the water was transferred to scintillation vials and analyzed for TMA on a Gas Chromatograph-Mass Spectrophotometer. The results are shown in Table 2 below.

TABLE 2

| | | | Average TMA |
|---|---|---|---|
| Binder No. | TMA (ppm) | TMA (ppm) | (ppm) |
| 1 | 88 | 83 | 86 |
| 2 | 77 | 85 | 81 |
| 3 | 125 | 115 | 120 |
| 4 | 15 | 12 | 14 |
| 5 | 116 | 104 | 110 |
| 6 | 137 | 120 | 129 |

### EXAMPLE 4

### Binder Preparation

Using the same ingredients and procedures as Example 2, additional binder compositions were made at a solids concentration of 15 wt. %. The parts by weight of the various ingredients are illustrated in Table 3 as follows:

TABLE 3

| PREMIX | | | | | BINDER | | | | |
|---|---|---|---|---|---|---|---|---|---|
| (parts by weight) | | | | | (parts by weight) | | | | |
| Binder | PF | 40% | Triazone | 28% | | | 20% | | |
| No. | Resin | Urea | Resin | NH₄OH | Premix | Water | NH₄SO₄ | CuCl₂ | CuSO₄ |
| 7 | 182.1 | 103.1 | — | 1.88 | 287.1 | 529.1 | 17.2 | — | — |
| 8 | 123.6 | 107.8 | 53.2 | 1.88 | 286.5 | 529.6 | 17.2 | — | — |
| 9 | 123.6 | 107.8 | 53.2 | 1.88 | 286.5 | 528.4 | 17.2 | 1.25 | — |
| 10 | 123.6 | 107.8 | 53.2 | 1.88 | 286.5 | 523.4 | 17.2 | 6.25 | — |
| 11 | 123.6 | 107.8 | 53.2 | 1.88 | 286.5 | 517.1 | 17.2 | 12.5 | — |
| 12 | 123.6 | 107.8 | 53.2 | 1.88 | 286.5 | 517.1 | 17.2 | | 12.5 |

As above, 28% ammonium hydroxide also was added as needed to adjust the pH of each of the binder formulations to 8.0. In particular, 0.70 parts, 0.48 parts, 1.9 parts, 8.8 parts, 15 parts and 8.2 parts ammonium hydroxide was added to binders 7-12, respectively.

### EXAMPLE 5

### Preparation of Molded Fiberglass

Using the same procedure as Example 3, the binder preparations 7 through 12 were separately applied to one inch (2.54 cm) B-010 fiberglass to make one inch (2.54 cm) cubes of cured fiberglass mats and were similarly tested for TMA content according to the same procedure. The analysis results for TMA using a Gas Chromatograph-Mass Spectrophotometer are shown in Table 4 below.

TABLE 4

| | | | Average TMA |
|---|---|---|---|
| Binder No. | TMA (ppm) | TMA (ppm) | (ppm) |
| 7 | 98 | 101 | 100 |
| 8 | 96 | 100 | 98 |
| 9 | 88 | 83 | 86 |
| 10 | 50 | 47 | 49 |
| 11 | 16 | 21 | 19 |
| 12 | 63 | 68 | 66 |

The present invention has been described with reference to specific embodiments. However, this application is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass + or −5% and preferably is only about + or −2%.

We claim:

1. An aqueous binder composition suitable for making glass fiber products comprising (1) a phenol-formaldehyde resole resin that has been treated with urea, melamine, ammonia, or some combination thereof for reducing formaldehyde emission and (2) a copper or vanadium odor-eliminating agent.

2. The aqueous binder of claim 1 wherein the odor-eliminating agent is selected from copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅).

3. The aqueous binder of claim 2 wherein the aqueous binder also comprises an additive selected from a urea-formaldehyde resin and a cyclic urea prepolymer.

4. The aqueous binder of clam 2 wherein the phenol-formaldehyde resole resin is made at a formaldehyde to phenol mole ratio of between 2:1 to 6:1.

5. The aqueous binder of claim 4 wherein the odor-eliminating agent is present in an amount of 1 to 20 weight percent based on the weight of curable binder solids.

6. The aqueous binder of claim 5 wherein the odor-eliminating agent is present in an amount of 5 to 15 weight percent.

7. The aqueous binder of claim 5 wherein the odor-eliminating agent is cupric chloride.

8. The aqueous binder of clam 3 wherein the phenol-formaldehyde resole resin is made at a formaldehyde to phenol mole ratio of between 2:1 to 6:1.

9. The aqueous binder of claim 8 wherein the odor-eliminating agent is present in an amount of 1 to 20 weight percent based on the weight of curable binder solids.

10. The aqueous binder of claim 9 wherein the odor-eliminating agent is present in an amount of 5 to 15 weight percent.

11. The aqueous binder of claim 9 wherein the odor-eliminating agent is cupric chloride.

12. A method for binding together a loosely associated mat of glass fibers comprising (A) applying onto said glass fibers an aqueous binder composition comprising (1) a phenol-formaldehyde resole resin that has been treated with urea, melamine, ammonia, or some combination thereof for reducing formaldehyde emission and (2) a copper or vanadium odor-eliminating agent and (B) heating said binder composition at an elevated temperature sufficient to effect cure of the binder.

13. The method of claim 12 wherein the odor-eliminating agent is selected from copper (II) chloride, copper (II) sulfate, copper (II) borate, copper (II) formate, copper (I) oxalate, copper (II) acetate, copper (II) tartrate, copper (II) citrate, copper (II) lactate, vanadium (IV) chloride and vanadium oxide (V₂O₅).

14. The method of claim 13 wherein the aqueous binder also comprises an additive selected from a urea-formaldehyde resin and a cyclic urea prepolymer.

15. The method of clam 13 wherein the phenol-formaldehyde resole resin is made at a formaldehyde to phenol mole ratio of between 2:1 to 6:1.

16. The method of claim 13 wherein the odor-eliminating agent is present in an amount of 1 to 20 weight percent based on the weight of curable binder solids.

17. The method of claim 16 wherein the odor-eliminating agent is present in an amount of 5 to 15 weight percent.

18. The method of claim 16 wherein the odor-eliminating agent is cupric chloride.

19. The method of clam 14 wherein the phenol-formaldehyde resole resin is made at a formaldehyde to phenol mole ratio of between 2:1 to 6:1.

20. The method of claim 19 wherein the odor-eliminating agent is present in an amount of 1 to 20 weight percent based on the weight of curable binder solids.

21. The method of claim 20 wherein the odor-eliminating agent is present in an amount of 5 to 15 weight percent.

22. The method of claim 20 wherein the odor-eliminating agent is cupric chloride.

23. A glass fiber product obtained by heating a mat of nonwoven glass fibers onto which has been applied an aqueous binder composition, wherein the aqueous binder composition comprises (1) a phenol-formaldehyde resole resin that has been treated with urea, melamine, ammonia, or some combination thereof for reducing formaldehyde emission and (2) a copper or vanadium odor-eliminating agent.

24. The glass fiber product of claim 23 wherein the odor-eliminating agent is selected from the group consisting of copper (II) chloride, copper (II) sulfate, copper (II) borate, copper (II) formate, copper (II) oxalate, copper (II) acetate, copper (II) tartrate, copper (II) citrate, copper (II) lactate, vanadium (IV) chloride and vanadium oxide (V₂O₅).

25. The glass fiber product of claim 24 wherein the glass fiber product is a fiberglass insulation product.

26. The glass fiber product of claim 24 wherein the phenol-formaldehyde resole resin is made at a formaldehyde to phenol mole ratio of between 2:1 to 6:1 and the odor-eliminating agent is present in an amount of 1 to 20 weight percent based on the weight of curable binder solids.

27. The glass fiber product of claim 24 wherein the odor-eliminating agent is cupric chloride.

28. The glass fiber product of claim 26 wherein the odor-eliminating agent is cupric chloride.
